(19) United States
(12) Patent Application Publication
(10) Pub. No.: US 2009/0121977 A1
(43) Pub. Date: May 14, 2009

(54) Plasma display and driving method thereof

(76) Inventor: Hak-Cheol Yang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,878

(22) Filed: Nov. 6, 2008

(30) Foreign Application Priority Data
Nov. 9, 2007 (KR) 10-2007-0114282

(51) Int. Cl. G09G 3/28

(52) U.S. Cl. 345/60

(57) ABSTRACT

A plasma display device includes a plurality of scan lines, each scan line corresponding to a plurality of discharge cells, a controller and a driver. The controller may be adapted to determine, for at least one of the plurality of scan lines, a width of a scan pulse to be applied based on a load ratio of the respective scan line. The driver may be adapted to sequentially apply the respective scan pulse of the determined width to the plurality of scan lines.

### BACKGROUND OF THE INVENTION

1. Field of the Invention

Embodiments relate to plasma display devices and driving methods thereof.

2. Description of the Related Art

A plasma display device is a display device that includes a plasma display panel (PDP) for displaying characters or images using plasma generated according to gas discharge.

A plasma display device is generally driven by dividing a frame into a plurality of subfields that each have a luminance weight value. The plasma display device may display a grayscale based on a combination of weight values of the subfields, among a plurality of subfields, in which a display operation is generated. In general, during an address period of each of the subfields, a scan pulse is sequentially applied to a plurality of scan electrodes, and an address pulse is selectively applied to a plurality of address electrodes. More particularly, the address pulse is selectively applied or not applied to the respective address electrode when the scan pulse is applied to each scan electrode so that a corresponding light emitting cell or a corresponding non-light emitting cell is selected. An address discharge occurs in a cell defined by respective portions of the scan electrode and the address electrode to which the scan pulse and the address pulse were respectively applied.

In general, a discharge that is triggered by a voltage applied between the scan and address electrodes occurs after a delay from when the voltage is applied thereto. Since the address discharge is set to occur within a width of the scan pulse and the address pulse, the address discharge may not occur when a discharge delay is greater than the width of the scan pulse and the address pulse. Further, a voltage drop may increase when the number of light emitting cells in a scan line defined by a scan electrode applied with the scan pulse is increased. As a result, the discharge delay may increase. Thus, the width of the scan pulse should be long enough to ensure that the address discharge occurs stably. Therefore, the address period may need to be increased.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

Embodiments of the present invention are therefore directed to plasma display devices and driving methods thereof, which substantially overcome one or more the problems due to the limitations and disadvantages of the related art.

It is therefore a feature of an embodiment of the present invention to provide a plasma display that may reduce and/or minimize an address period, while still enabling a stable address discharge.

It is therefore a separate feature of an embodiment of the present invention to provide a driving method for a plasma display that may reduce and/or minimize an address period, while still enabling a stable address discharge.

It is therefore a feature of an embodiment of the present invention to provide a plasma display, including a plurality of scan lines, each scan line corresponding to a plurality of discharge cells, a controller adapted to determine, for at least one of the plurality of scan lines, a width of a scan pulse to be applied based on a load ratio of the respective scan line, and a driver adapted to sequentially apply the respective scan pulse of the determined width to the plurality of scan lines.

The controller may divide one frame into a plurality of subfields, each subfield including an address period, and during the respective address period of the plurality of subfields, the driver may sequentially apply the respective scan pulse of the determined width to the respective one of the plurality of scan lines.

The controller may determine the load ratio of each scan line according to a light emitting state of the plurality of discharge cells corresponding to the respective scan line during a respective subfield.

The controller may determine, for each of the plurality of scan lines, a width of a scan pulse to be applied based on a load ratio of the respective scan line.

The controller may determine the width of the scan pulse to be longer as the load ratio of the corresponding scan line is greater.

The controller may include a subfield generator adapted to generate subfield data indicating respective light emitting/non-light emitting states of the plurality of discharge cells using image data input during the frame, and a line load ratio calculator adapted to calculate the respective load ratio of the plurality of scan lines using the subfield data, wherein respective bits of the subfield data may correspond to each of the subfields.

The plasma display device may further include a plurality of address lines crossing the plurality of scan lines, wherein the driver may apply a respective address pulse to the address lines according to the subfield data when the corresponding scan pulse is applied to one of the plurality of scan lines during the address period, and a width of the corresponding address pulse may increase as the corresponding scan pulse increases.

The controller may determine a width of a scan pulse to be applied to a first of the plurality of scan lines to be a first width when a first number of the discharge cells corresponding to the first scan line are set to a light emitting state during a first subfield and determine a width of a scan pulse to be applied to the first scan line of the plurality of scan lines to be a second width when a second number of the discharge cells corresponding to the first scan line are set to the light emitting state during the first subfield, and when the second number is different the first number, the first width may be different from the second width.

The first width may be longer than the second width when the first number is greater than the second number.

The controller may determine a width of a scan pulse to be applied to the second scan line to be a third width that is different from the first width when a number of the light emitting cells corresponding to the second scan line is a third number that is different from the first number during the first subfield.

The first width may be longer than the third width when the first number is greater than the third number.

It is therefore a separate feature of an embodiment of the present invention to provide a method for driving a plasma display including a plurality of scan electrodes, a plurality of address electrodes crossing the plurality of scan electrodes, and a plurality of discharge cells defined by the plurality of scan electrodes and the plurality of address electrodes, the method including dividing a frame into a plurality of subfields, generating subfield data indicating respective light emitting/non-light emitting states of the plurality of discharge cells using image data input during the frame, calculating a load ratio for at least one of the plurality of scan electrodes using the subfield data, determining a width of a scan pulse to be applied to the respective scan electrode according to the calculated load ratio, and applying a driving signal to the respective scan electrode according to the width of the scan pulse.

Calculating may include calculating a respective load ratio for each of the plurality of scan electrodes using the subfield data, determining may include determining a respective width of a scan pulse to be applied to be applied to the respective scan electrode according to the respective calculated load ratio, applying a driving signal may include applying a respective driving signal to the respective scan electrode according to the respective width of the scan pulse.

Determining a width of a scan pulse may include increasing the width of the respective scan pulse as the corresponding load ratio increases.

The method may further include determining a width of a respective address pulse to be applied to the plurality of address electrodes according to the corresponding load ratio of the scan electrode to which a corresponding scan pulse is to be applied, and applying a driving signal to the plurality of address electrodes according to the subfield data and the respective width of the address pulse.

Determining a width of a respective address pulse may include increasing the width of the address pulse as the corresponding load ratio of the scan electrode to which a corresponding scan pulse is to be applied increases.

It is therefore a separate feature of an embodiment of the present invention to provide a method of driving a plasma display including a plurality of scan electrodes and a plurality of address electrodes crossing the plurality of scan electrodes, while dividing a frame into a plurality of subfields, the method comprising, during an address period of the plurality of subfields: sequentially applying a corresponding scan pulse to the plurality of scan electrodes, and selectively applying an address pulse to the plurality of address electrodes when the corresponding scan pulse is applied, wherein a width of the corresponding scan pulse is determined according to a number of the address electrodes to which the address pulse is applied when the corresponding scan pulse is applied.

A width of a corresponding scan pulse applied to a first scan electrode when a number of address electrodes to be applied with the address pulse is a first number that may be longer than a width of a corresponding scan pulse applied to a second scan electrode when a number of the address electrodes to be applied with the address pulse is a second number that is less than the first number.

An address discharge may occur when the scan electrode is applied with the corresponding scan pulse and the respective address electrode is applied with the corresponding address pulse such that a light emitting cell is selected for address discharge.

The width of the corresponding address pulse when the corresponding scan pulse is applied to the second scan electrode may be longer than the width of the address pulse when the corresponding scan pulse is applied to the first scan electrode.

According to an exemplary embodiment of the present invention, the address period may be reduced and luminance of an image may be increased when the reduced period is allocated to the sustain period.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a diagram of a plasma display device according to an exemplary embodiment of the present invention;

FIG. 2 illustrates a diagram of subfields and their corresponding weight value according to an exemplary embodiment of the present invention;

FIG. 3 illustrates a driving waveform diagram employable to drive the plasma display device of FIG. 1 according to an exemplary embodiment of the present invention;

FIG. 4 illustrates a block diagram of a controller according to an exemplary embodiment of the present invention;

FIG. 5 illustrates a flowchart of an exemplary operation of the controller of FIG. 4 according to an exemplary embodiment of the present invention; and

FIG. 6 illustrates a diagram of an exemplary method of determining the width of a scan pulse.

### DETAILED DESCRIPTION OF THE INVENTION

Korean Patent Application No. 10-2007-0114282, filed on Nov. 9, 2007, in the Korean Intellectual Property Office, and entitled: “Plasma Display and Driving Method Thereof,” is incorporated by reference herein in its entirety.

Exemplary embodiments of the present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

Throughout the specification, if something is described to “include constituent elements,” it may further include other constituent elements unless it is described that it does not include other constituent elements.

In the following description, it will be understood that a wall charge is a charge formed close to each electrode on the wall of a cell, e.g., a dielectric layer. Although the wall charges may not actually touch the electrodes, the wall charges will be described as being “formed” or “accumulated” on the electrode. Also, a wall voltage is a potential difference formed at the wall of a cell by wall charges. A weak discharge is a discharge that is weaker than a sustain discharge in a sustain period and an address discharge in an address period.

An exemplary plasma display device and an exemplary driving method thereof according to the exemplary embodiment of the present invention will now be described in detail.

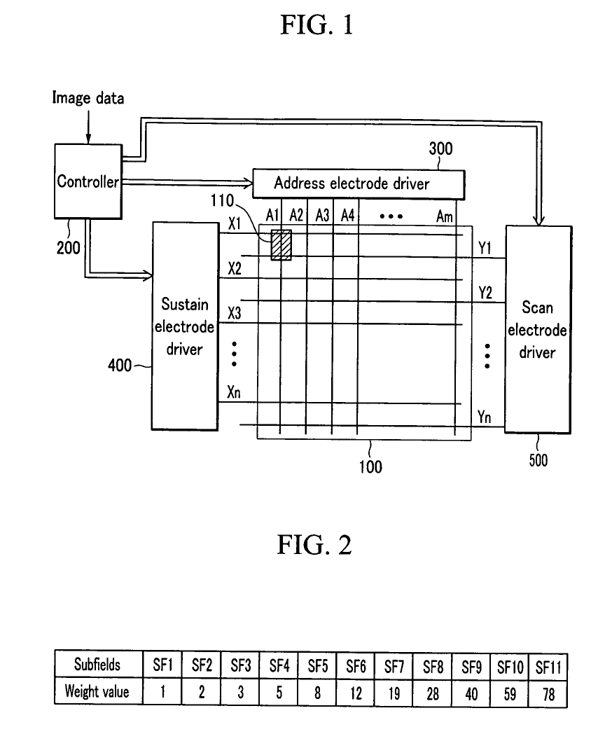

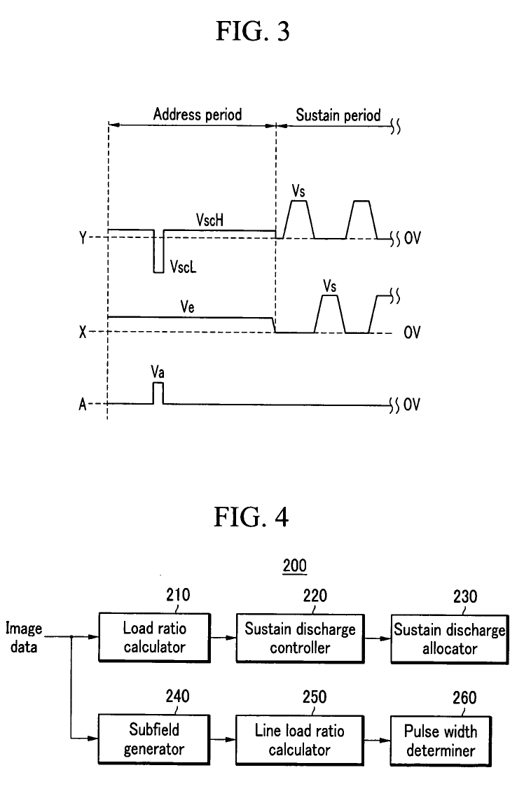

FIG. 1 illustrates a diagram of a plasma display device according to an exemplary embodiment of the present invention, and FIG. 2 illustrates a diagram of subfields and their corresponding weight value according to an exemplary embodiment of the present invention. FIG. 3 illustrates a driving waveform diagram employable to drive the plasma display device of FIG. 1 according to an exemplary embodiment of the present invention. For ease of description, FIG. 3 shows only an A electrode, an X electrode, and a Y electrode. It is understood that features described therewith may be applied to a plurality of A electrodes, a plurality of X electrodes and/or a plurality of Y electrodes, respectively. Further, for ease of description, in FIG. 3, the exemplary driving waveform will be described with reference to a single cell defined by an A electrode, an X electrode, and a Y electrode. It is understood that features described therewith may be applied to other electrodes and/or cells.

As shown in FIG. 1, a plasma display device according to an exemplary embodiment of the present invention may include a plasma display panel 100, a controller 200, an address electrode driver 300, a sustain electrode driver 400, and a scan electrode driver 500.

The plasma display panel 100 may include a plurality of address electrodes Al-Am (referred to as “A electrodes” hereinafter) extending in a column direction, and a plurality of sustain electrodes X1˜Xn (referred to as “X electrodes” hereinafter) and a plurality of scan electrodes Y1˜Yn (referred to as “Y electrodes” hereinafter) extending in a row direction, making pairs. In general, the X electrodes X1˜Xn may be arranged to correspond to the respective Y electrodes Y1˜Yn. The X electrodes X1˜Xn and the Y electrodes Y1˜Yn may perform a display operation during a sustain period to display an image. The Y electrodes Y1˜Yn and the X electrodes X1˜Xn may be disposed to cross the A electrodes A1˜Am. A plurality of scan lines may be defined by the Y electrodes Y1˜Yn applied with a scan pulse during an address period, and a plurality of address lines may be defined by the A electrodes A1-Am applied with an address pulse during the address period. In addition, discharge spaces present at crossing portions of corresponding ones of the A electrodes A1˜Am, the X electrodes X1˜Xn and the Y electrodes Y1˜Yn may define discharge cells 110.

The structure of the PDP 100 illustrated in FIG. 1 and described above is one example to which one or more aspects of the invention may be applied. One or more aspects of the invention described herein may be applied to a panel with a different structure. More particularly, e.g., driving waveforms including one or more features described herein may be applied to panels having different structures.

The controller 200 may receive externally supplied image data and may output an A electrode driving control signal, an X electrode driving control signal, and a Y electrode driving control signal.

The controller 200 may drive a frame by dividing it into a plurality of subfields. Each subfield may have a luminance weight value. Each subfield may include an address period and a sustain period. As shown in FIG. 2, one frame may include 11 subfields SF1-SF11 respectively having weight values 1, 2, 3, 5, 8, 12, 18, 19, 40, 59, and 78, and grayscales may be displayed from the grayscale 0 to the grayscale 255.2.

The controller 200 may convert image data that is input during one frame into subfield data indicating respective light emitting/non-light emitting states of the plurality of discharge cells 110 in the plurality of subfields (SF1-SF11 in FIG. 2). The controller 200 may determine a width of a scan pulse and a width of an address pulse to be applied to each scan line and each address line, respectively, according to a ratio of a light emitting cell in each scan line. Hereinafter, a ratio of the light emitting cell in the scan line will be defined as a “line load ratio.”

The controller 200 may also calculate a screen load ratio using the image input during the one frame and may determine a total number of sustain pulses allocated to the one frame using the screen load ratio. The controller 200 may allocate the determined number of sustain pulses to each subfield (SF1-SF11 in FIG. 2). For example, the controller 200 may allocate the Determined number of sustain pulses to each subfield SF1-SF11 based on weight values of the respective subfields SF1-SF11.

The controller 200 may apply driving control signals to the address, scan, and sustain electrode drivers 300, 400, and 500 according to subfield data, the determined number of sustain pulses, the width of the scan pulse, and the width of the address pulse.

The address electrode driver 300 may receive the A electrode driving control signal from the controller 200 and may apply a driving voltage to the A electrodes. The sustain electrode driver 400 may receive the X electrode driving control signal from the controller 200 and may apply a driving voltage to the X electrodes. The scan electrode driver 500 may receive the Y electrode driving control signal from the controller 200 and may apply a driving voltage to the Y electrodes.

In detail, as shown in FIG. 3, during an address period, to select a light emitting cell 110 among the plurality of discharge cells in each subfield, the sustain electrode driver 400 may maintain a voltage of the X electrode at a voltage Ve, and the scan electrode driver 500 and the address electrode driver 300 may apply a scan pulse having the voltage VscL and an address pulse having the voltage Va to the Y electrode and the A electrode, respectively. To select a non-light emitting cell among the plurality of the discharge cells 110, the sustain electrode driver 400 may maintain a voltage of the X electrode at a voltage Ve, the scan electrode driver 500 may apply a non-selected Y electrode with the voltage VscH that is higher than the voltage of VscL, and the address electrode driver 300 may apply a corresponding A electrode of the non-light emitting cell with a ground voltage.

In more detail, during the address period, the scan electrode driver 500 and the address electrode driver 300 may apply scan pulses to the Y electrode (Y1 in FIG. 1) of a first row and, at the same time, apply address pulses to the A electrodes defining light emitting cells in the first row, respectively. Then, address discharges may occur between the Y electrode (Y1 in FIG. 1) of the first row and the A electrodes to which the address pulses have been applied, forming positive (+) wall charges at the Y electrode (Y1 in FIG. 1) and negative (−) wall charges at the A and X electrodes. Subsequently, while the scan electrode driver 500 is applying scan pulses to the Y electrodes (Y2 in FIG. 1) of a second row, the address electrode driver 300 may apply address pulses to the A electrodes defining light emitting cells in the second row. Then, address discharges occur at the light emitting cells defined by the A electrodes to which the address pulses have been applied and the Y electrode (Y2 in FIG. 1) of the second row, forming wall charges at the cells.

Likewise, the scan electrode driver 500 may sequentially apply scan pulses to the Y electrodes of the remaining rows. While the respective scan pulses are being applied to the remaining rows, the address electrode driver 300 may apply address pulses to the A electrodes defining corresponding light emitting cells in the respective row of the plasma display panel 100 to form wall charges.

To select a light emitting cell and/or a non-light emitting cell during the address period, the exemplary embodiment of the present invention described above employs selective write addressing for selecting the light emitting cell(s) and forming a wall charge at the light emitting cell(s), as shown the FIG. 3. Embodiments of the invention are not limited thereto.

For example, embodiments of the invention may employ selective erase addressing for selecting the non-light emitting cell and erasing a wall charge formed at the non-light-emitting cell(s). When selective erase addressing is employed, discharge cells should be in the non-light emitting state just before the address period applies the selective erase address to enable erasing discharge in the address period.

Referring still to FIG. 3, during the sustain period, the scan electrode driver 500 may apply the sustain pulse alternately having a high level voltage, e.g., Vs in FIG. 2, and a low level voltage, e.g., 0V in FIG. 2, to the Y electrodes a number of times based on a weight value of the corresponding subfield. The sustain electrode driver 400 may apply a sustain pulse to the X electrodes in a phase opposite to that of the sustain pulse applied to the Y electrodes. That is, e.g., 0V may be applied to the X electrode when a VS voltage is applied to the Y electrode and the VS voltage may be applied to the X electrode when 0V is applied to the Y electrode.

In this case, the voltage difference between corresponding ones of the Y electrodes and the X electrodes may alternate between a Vs voltage and a −Vs voltage. Accordingly, sustain discharge may repeatedly occur at light emitting cells as many times as the predetermined number corresponding to a weight value of the corresponding subfield. Embodiments are not limited to such voltage applications to the Y electrodes and X electrodes. For example, in some embodiments, during the sustain period, a sustain pulse alternately having a Vs voltage and a −Vs voltage may be applied to only one electrode among the corresponding Y electrode and the X electrode, and a voltage of 0V may be applied to the other of the corresponding X or Y electrode. In such cases, the voltage difference between the Y electrode and the X electrode may alternate between has a Vs voltage and a −Vs voltage. Thus, sustain discharge may occur at light emitting cells.

An exemplary method for determining the width of the scan pulse and address pulse according to the line load ratio in the controller 200 will be described in detail with reference to FIGS. 4 to 6.

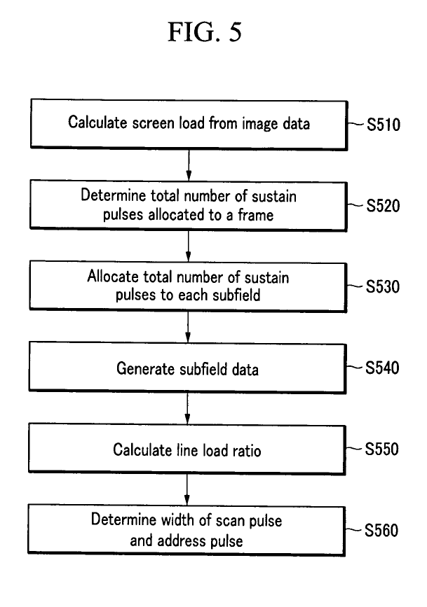

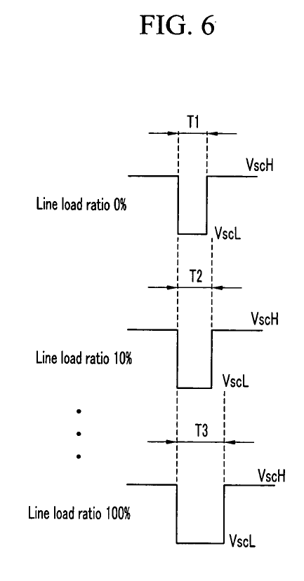

FIG. 4 illustrates a block diagram of the controller 200 according to an exemplary embodiment of the present invention. FIG. 5 illustrates a flowchart of an exemplary operation of the controller 200 of FIG. 4 according to an exemplary embodiment of the present invention. FIG. 6 illustrates a diagram of an exemplary method of determining a width of a scan pulse.

As shown in FIG. 4, the controller 200 may include a screen load ratio calculator 210, a sustain discharge controller 220, a sustain discharge allocator 230, a subfield generator 240, a line load ratio calculator 250, and a pulse width determiner 260.

Referring to FIGS. 4 and 5, the screen load ratio calculator 210 may calculate a screen load ratio using image data input during one frame, in operation S510. For example, the screen load ratio calculator 210 may calculate the screen load ratio from an average signal level of the image data during the one frame.

The sustain discharge controller 220 may determine a total number of sustain pulses allocated to one frame according to the screen load ratio, in operation S520. In some embodiments, e.g., the sustain discharge controller 220 may determine a total number of sustain pulses according to the screen load ratio from a look-up table therein, or may calculate the total number of sustain pulses by performing a logic operation on data corresponding to the screen load ratio. In some embodiments, when a number of light emitting cells is increased and a screen load ratio is increased, a total number of sustain pulses may be decreased to reduce and/or prevent an increase of power consumption.

The sustain discharge allocator 230 may allocate the total number of sustain pulses to each subfield (SF1-SF11 in FIG. 2) in proportion to weight values of the respective subfields (SF1-SF11), in operation S530.

The subfield generator 240 may generate subfield data using the image data input during one frame, in operation 540. The subfield data may indicate respective light emitting/non-light emitting states of the plurality of discharge cells (110 in FIG. 1) in the plurality of subfields (SF1-SF11 in FIG. 2). In the exemplary embodiment shown in FIG. 2, from the weights of each subfield, e.g., SF1-SF11, image data of 120 grayscales may be generated to subfield data of “10011011010.” Here, “10011011010” respectively corresponds to the plurality of subfields SF1 to SF11, where “1” indicates that the respective discharge cell 110 is light-emitting in a corresponding subfield, and “0” indicates that the respective discharge cell 110 is non light-emitting in the corresponding subfield.

The line load ratio calculator 250 may calculate a line load ratio in each subfield using the subfield data, in operation S550.

The pulse width determiner 260 may determine a width of the scan pulse applied to the respective scan electrode and a width of the address pulse applied to the respective address electrode, according to the calculated line load ratio, in operation S560. In some embodiments, the pulse width determiner 260 may determine a width of the scan pulse according to the line load ratio from a look-up table stored therein. That is, as shown in FIG. 6, the pulse width determiner 260 may set a width of a scan pulse to be applied to the corresponding scan line to be a first predetermined length T1 when the line load ratio is the smallest, e.g., the line load ratio is “0”, and may set a width of a scan pulse to be applied to the corresponding scan line to be a second predetermined length T2, which is longer than the length T1, when the line load ratio is larger than the smallest value, e.g., when the line load ratio is 10%. Further, e.g., the pulse width determiner 260 may set a width of the scan pulse applied to the corresponding scan line to be a predetermined third length T3, which is longer than the length T2, when the line load ratio is still greater, e.g., when the line load ratio is 100%.

In embodiments, although a discharge delay may become greater as a line load ratio increases, because a width of a scan pulse may be increased as a line load ratio is relatively greater, an address discharge may occur within a width of the scan pulse. Further, because a width of the scan pulse may decrease when a line load ratio is relatively lower, an address period may be reduced. In embodiments, luminance may be improved when a reduced period is allocated for a sustain period.

In embodiments, because an address discharge may be set to occur within a width of a corresponding scan pulse and a width of a corresponding address pulse, the pulse width determiner 260 may set a width of a corresponding address pulse to be longer as the line load ratio becomes greater.

In embodiments, because a width of a scan pulse may be changed according to a line load ratio, a width of a scan pulse for a same scan line of each subfield may be different. Likewise, a width of an address pulse for cells formed in a same scan line may also be different in different subfields.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display, comprising:
a plurality of scan lines, each scan line corresponding to a plurality of discharge cells;
a controller adapted to determine, for at least one of the plurality of scan lines, a width of a scan pulse to be applied based on a load ratio of the respective scan line; and
a driver adapted to sequentially apply the respective scan pulse of the determined width to the plurality of scan lines.

2. The plasma display as claimed in claim 1, wherein:
the controller is adapted to divide one frame into a plurality of subfields, each subfield including an address period, and
during the respective address period of the plurality of subfields, the driver is adapted to sequentially apply the respective scan pulse of the determined width to the respective one of plurality of scan lines.

3. The plasma display as claimed in claim 2, wherein the controller is adapted to determine the load ratio of each scan line according to a light emitting state of the plurality of discharge cells corresponding to the respective scan line during a respective subfield.

4. The plasma display as claimed in claim 2, wherein the controller is adapted to determine, for each of the plurality of scan lines, a width of a scan pulse to be applied based on a load ratio of the respective scan line.

5. The plasma display as claimed in claim 2, wherein the controller is adapted to determine the width of the scan pulse to be longer as the load ratio of the corresponding scan line is greater.

6. The plasma display as claimed in claim 5, wherein the controller comprises:
a subfield generator adapted to generate subfield data indicating respective light emitting/non-light emitting states of the plurality of discharge cells using image data input during the frame; and
a line load ratio calculator adapted to calculate the respective load ratio of the plurality of scan lines using the subfield data,
wherein respective bits of the subfield data correspond to each of the subfields.

7. The plasma display as claimed in claim 6, further comprising:
a plurality of address lines crossing the plurality of scan lines,
wherein:
the driver is adapted to apply a respective address pulse to the address lines according to the subfield data when the corresponding scan pulse is applied to one of the plurality of scan lines during the address period, and
a width of the corresponding address pulse increases as the corresponding scan pulse increases.

8. The plasma display as claimed in claim 1, wherein the controller is adapted to:
determine a width of a scan pulse to be applied to a first of the plurality of scan lines to be a first width when a first number of the discharge cells corresponding to the first scan line are set to a light emitting state during a first subfield, and
determine a width of a scan pulse to be applied to the first scan line of the plurality of scan lines to be a second width when a second number of the discharge cells corresponding to the first scan line are set to the light emitting state during the first subfield, wherein,
when the second number is different the first number, the first width is different from the second width.

9. The plasma display as claimed in claim 8, wherein the first width is longer than the second width when the first number is greater than the second number.

10. The plasma display as claimed in claim 8, wherein the controller is adapted to determine a width of a scan pulse to be applied to the second scan line to be a third width that is different from the first width when a number of the light emitting cells corresponding to the second scan line is a third number that is different from the first number during the first subfield.

11. The plasma display as claimed in claim 10, wherein the first width is longer than the third width when the first number is greater than the third number

12. A method for driving a plasma display including a plurality of scan electrodes, a plurality of address electrodes crossing the plurality of scan electrodes, and a plurality of discharge cells defined by the plurality of scan electrodes and the plurality of address electrodes, the method comprising:
dividing a frame into a plurality of subfields;
generating subfield data indicating respective light emitting/non-light emitting states of the plurality of discharge cells using image data input during the frame;
calculating a load ratio for at least one of the plurality of scan electrodes using the subfield data;
determining a width of a scan pulse to be applied to the respective scan electrode according to the calculated load ratio; and
applying a driving signal to the respective scan electrode according to the width of the scan pulse.

13. The method as claimed in claim 12, wherein:
calculating includes calculating a respective load ratio for each of the plurality of scan electrodes using the subfield data,
determining including determining a respective width of a scan pulse to be applied to be applied to the respective scan electrode according to the respective calculated load ratio, and
applying a driving signal including applying a respective driving signal to the respective scan electrode according to the respective width of the scan pulse.

14. The method as claimed in claim 12, wherein determining a width of a scan pulse includes increasing the width of the respective scan pulse as the corresponding load ratio increases.

15. The method as claimed in claim 14, further comprising
determining a width of a respective address pulse to be applied to the plurality of address electrodes according to the corresponding load ratio of the scan electrode to which a corresponding scan pulse is to be applied; and
applying a driving signal to the plurality of address electrodes according to the subfield data and the respective width of the address pulse.

16. The method as claimed in claim 15, wherein determining a width of a respective address pulse includes increasing the width of the address pulse as the corresponding load ratio of the scan electrode to which a corresponding scan pulse is to be applied increases.

17. A method of driving a plasma display including a plurality of scan electrodes and a plurality of address electrodes crossing the plurality of scan electrodes, while dividing a frame into a plurality of subfields, the method comprising, during an address period of the plurality of subfields:
sequentially applying a corresponding scan pulse to the plurality of scan electrodes; and
selectively applying an address pulse to the plurality of address electrodes when the corresponding scan pulse is applied,
wherein a width of the corresponding scan pulse is determined according to a number of the address electrodes to which the address pulse is applied when the corresponding scan pulse is applied.

18. The method as claimed in claim 17, wherein a width of a corresponding scan pulse applied to a first scan electrode when a number of address electrodes to be applied with the address pulse is a first number is longer than a width of a corresponding scan pulse applied to a second scan electrode when a number of the address electrodes to be applied with the address pulse is a second number that is less than the first number.

19. The method as claimed in claim 18, wherein an address discharge occurs when the scan electrode is applied with the corresponding scan pulse and the respective address electrode is applied with the corresponding address pulse such that a light emitting cell is selected for address discharge.

20. The method as claimed in claim 19, wherein the width of the corresponding address pulse when the corresponding scan pulse is applied to the second scan electrode is longer than the width of the address pulse when the corresponding scan pulse is applied to the first scan electrode.
